(19) United States
(12) Patent Application Publication
(10) Pub. No.: US 2025/0334139 A1
(43) Pub. Date: Oct. 30, 2025

(54) STRUT CONNECTION BRACKET AND STRUT CONNECTION DEVICE INCLUDING THE SAME

(71) Applicants: Seung Kueon SEO, Seoul (KR); Yoon Young SEO, Seoul (KR); Kyeng Sik SEO, Seoul (KR); HENCE CONSTRUCTION CO., LTD., Seoul (KR); GLOBAL GEO CO., LTD., Seoul (KR)

(72) Inventors: Seung Kueon SEO, Seoul (KR); Yoon Young SEO, Seoul (KR); Kyeng Sik SEO, Seoul (KR)

(21) Appl. No.: 19/186,152

(22) Filed: Apr. 22, 2025

(30) Foreign Application Priority Data
Apr. 25, 2024 (KR) 10-2024-0055198

(51) Int. Cl. F16B 7/04; E02D 29/02; F16B 7/18

(52) U.S. Cl. CPC F16B 7/048; E02D 29/0266; F16B 7/18

(57) ABSTRACT

Described is a strut connection bracket which connects steel pipe struts supporting wales of a retaining wall and inclined struts inclinedly connected to the steel pipe struts to provide supporting force, the strut connection bracket including: arc portions, each including an arc-shaped body, which is formed in a semicircular shape corresponding to an outer circumferential surface of the steel pipe strut, and arc flanges, which are bent at the end of the arc-shaped body and have a plurality of first coupling holes; and connection portions, each integrally connected to one side of the arc-shaped body and including a plurality of second coupling holes, wherein the connection portion is connected to another adjacent connection portion or to the inclined strut.

### CROSS-REFERENCE TO RELATED APPLICATIONS

This application claims the benefit of Korean Patent Application No. 10-2024-0055198, filed with the Korean Intellectual Property Office on Apr. 25, 2024, the disclosure of which is incorporated herein by reference in its entirety.

### BACKGROUND OF THE INVENTION

### Field of the Invention

The present invention relates to a strut connection bracket that connects a strut, which provides supporting force to a wale of a retaining wall installed to support earth pressure during underground excavation work, to the wale, and to a strut connection device including the same.

### Background Art

In excavation work for foundation construction of subways, buildings, underpasses, underground storage facilities, etc., retaining wall construction for supporting earth pressure is also performed at the perimeter of an excavation site.

The retaining wall construction is intended to resist lateral pressures such as earth pressure and water pressure occurring during underground excavation. Recently, as excavation work in urban areas is frequently carried out, the use of the retaining wall construction has diversified for preventing ground subsidence and protecting surrounding buildings.

The retaining wall construction proceeds together with excavation work. In general, during the retaining wall construction, strut posts in the form of H-beams are erected on the ground at regular intervals, and a plurality of retaining plates are stacked and inserted between adjacent strut posts to form a retaining wall supporting soil or rock walls. Moreover, wales are connected laterally to the strut posts, and the opposing wales are connected by struts so that the retaining wall can withstand earth pressure.

The strut is intended to effectively support the earth pressure acting on the retaining wall and to prevent loss or collapse of soil of the excavated earth wall, and is generally arranged at regular intervals. A jack support may be fastened at a connection part between the wale and the strut to allow for adjustment of the strut length.

When the strut is connected to the wale, if an end of the strut is directly connected to the wale, the supporting force of the strut is concentrated on a narrow portion of the wale. In this case, there may arise a problem in which the number of struts needs to be increased to prevent deformation of the wale. To overcome the problem, a roughly Y-shaped structure may be installed between the wale and the strut to distribute the supporting force on the wale.

For example, Korean Patent No. 0698878 discloses a strut connection structure that can distribute and transmit force acting on the wale.

The strut connection structure disclosed in Korean Patent No. 0698878 includes two steel pipe struts installed inclinedly to both wales, a double steel pipe strut arranged on the inner sides of both wales, and a connector connecting the steel pipe struts and the double steel pipe strut. The connector has three surfaces, and on each of the three surfaces, the double steel pipe strut and the two steel pipe struts are connected.

However, in case of the conventional strut connection structure, if an interval between the two steel pipe struts connected to the wales needs to be changed according to construction conditions, a new connector suitable for the strut connection structure must be manufactured and used. Accordingly, the conventional strut connection structure is troublesome to use and has limited applicability.

As another example, Korean Patent No. 2112571 discloses a strut connection device that enables effective connection between a wale and a strut.

The strut connection device in Korean Patent No. 2112571 discloses a structure in which an H-beam is interposed between the steel pipe strut and the wale, and an inclined strut (H-beam) is connected to the H-beam to support a retaining wall.

However, in this case, the strut connection device has a disadvantage in that a connector must be separately manufactured between the steel pipe strut and the H-beam, resulting in increased cost and weakened workability.

In addition, the axial supporting force of the H-beam is approximately 100 tons, and the axial supporting force of the steel pipe strut is approximately 250 tons. In case of the structure where the H-beam is interposed between the steel pipe strut and the wale, there is a disadvantage in that the supporting force for supporting the wale of the retaining wall is partially reduced.

### PATENT LITERATURE

### Patent Documents

Patent Document 1: Korean Patent No. 10-0698878
Patent Document 2: Korean Patent No. 10-2112571

### SUMMARY OF THE INVENTION

Accordingly, the present invention has been made to solve the above-mentioned problems occurring in the prior arts, and it is an objective of the present invention to provide a strut connection bracket and a strut connection device including the same, which can significantly enhance axial supporting force by applying only circular steel pipe-type struts without using H-beams in a strut support structure linearly connecting opposing wales, thus stably supporting a retaining wall and facilitating the application of a connection structure with inclined struts arranged inclinedly.

To accomplish the above objective, according to the present invention, there is provided a strut connection bracket which connects steel pipe struts supporting wales of a retaining wall and inclined struts inclinedly connected to the steel pipe struts to provide supporting force, the strut connection bracket including: arc portions, each including an arc-shaped body, which is formed in a semicircular shape corresponding to an outer circumferential surface of the steel pipe strut, and arc flanges, which are bent at the end of the arc-shaped body and have a plurality of first coupling holes; and connection portions, each integrally connected to one side of the arc-shaped body and including a plurality of second coupling holes, wherein the connection portion is connected to another adjacent connection portion or to the inclined strut

The strut connection brackets are configured such that the arc portions are arranged symmetrically in a pair to surround the steel pipe strut in the circumferential direction and are joined together via first coupling members inserted into the plurality of first coupling holes. The connection portion is coupled to a connection portion of another adjacent strut connection bracket via second coupling members, or is coupled to a inclined strut bracket connected to an end of the inclined strut via the second coupling members.

The connection portion has a plate shape and is connected to the arc portion via a connection block connected to the center of the outer circumferential surface of the arc portion, and is arranged in parallel with the arc flanges.

The connection block includes at least one weight-reduction groove.

The inner circumferential surface of the arc-shaped body includes a contact support protrusion configured to be in contact with ends of a first steel pipe strut provided on one side and a second steel pipe strut provided on the other side inside the arc-shaped body to support the steel pipe struts.

The inner circumferential surface of the arc-shaped body includes an arc-shaped contact support protrusion formed on the inner circumferential surface of the arc-shaped body to have the same center as the inner circumferential surface of the arc-shaped body.

In another aspect of the present invention, there is provided a strut connection device including: steel pipe struts supporting wales of a retaining wall; inclined struts inclinedly connected to the steel pipe struts and the wales, respectively, and providing supporting force; and strut connection brackets configured to connect the steel pipe struts and the inclined struts.

The steel pipe struts are installed in a single row, and a connection portion is coupled to a inclined strut bracket connected to an end of the inclined strut via second coupling members.

The steel pipe struts are installed in at least two rows, connection portions arranged between adjacent rows of the steel pipe struts are coupled to each other via the second coupling members, and an outermost connection portion is coupled to a inclined strut bracket connected to an end of the inclined strut.

The steel pipe strut includes a slip prevention part configured to prevent the strut connection bracket from sliding in a longitudinal direction of the steel pipe strut due to a load acting on the inclined strut.

In a further aspect of the present invention, there is provided a strut connection device including: steel pipe struts supporting wales of a retaining wall; inclined struts inclinedly connected to the steel pipe struts and the wales, respectively, and providing supporting force; and strut connection brackets configured to connect the steel pipe struts and the inclined struts, wherein the steel pipe strut includes a central steel pipe strut positioned at a relatively central portion, and a plurality of auxiliary steel pipe struts of which at least one is arranged on each side of the central steel pipe strut in the longitudinal direction, and which are aligned along the same central axis as the central steel pipe strut, the strut connection brackets are installed between the central steel pipe strut and the auxiliary steel pipe struts, and between adjacent auxiliary steel pipe struts, and ends of the central steel pipe strut and the auxiliary steel pipe struts are in contact with and supported by a contact support protrusion.

According to the present invention, the strut connection bracket and the strut connection device including the same can significantly enhance axial supporting force by applying only circular steel pipe type struts without using H-beams in a strut support structure linearly connecting opposing wales, thus stably supporting a retaining wall and facilitating the application of a connection structure with inclined struts arranged inclinedly.

Additionally, by including the slip prevention part on the outer surface of the steel pipe strut or by including the contact support protrusion on the strut connection bracket, the strut connection bracket and the strut connection device including the same can prevent the strut connection bracket from slipping in the longitudinal direction of the steel pipe strut and changing the coupling position due to the load inclinedly acting on the strut connection bracket by the inclined strut

In addition, by including the connection part on the strut connection bracket, the strut connection bracket and the strut connection device including the same can allow easy connection of the inclined struts, and firmly connect the plurality of circular steel pipe struts, which are closely and parallelly arranged, to prevent mutual movement.

### BRIEF DESCRIPTION OF THE DRAWINGS

FIG. 1 is a view illustrating a state in which a strut connection device according to an embodiment of the present invention is installed.

FIG. 2 is a partially enlarged view of FIG. 1.

FIGS. 3A to 3C are a view illustrating various modifications of the strut connection device according to an embodiment of the present invention.

FIG. 4 is an exploded perspective view illustrating a coupling relationship between a strut connection bracket and a steel pipe strut according to an embodiment of the present invention.

FIG. 5 is a cross-sectional view illustrating the coupling relationship between the strut connection bracket and the steel pipe strut according to an embodiment of the present invention.

FIG. 6 is a sectional view taken along line VI-VI of FIG. 2.

FIG. 7 is a view illustrating a modification of FIG. 4.

FIG. 8 is a view illustrating a state in which the strut connection device according to an embodiment of the present invention is installed based on FIG. 7.

FIG. 9 is a partially enlarged view of FIG. 8.

### DETAILED DESCRIPTION OF THE PREFERRED EMBODIMENT

Hereinafter, embodiments of the present invention will be described in more detail with reference to the accompanying drawings. However, the present invention is not limited to the embodiments disclosed below and may be realized in various different forms. The embodiments of the present invention are provided only to make the disclosure of the present invention complete and to fully inform the scope of the invention to those skilled in the art. In the drawings, the same reference numerals denote the same components.

A strut connection device according to a preferred embodiment of the present invention is not only easier to manufacture than conventional devices, but also further enhances longitudinal supporting force for supporting wales, thus supporting a retaining wall more stably.

Specifically, the present invention can significantly enhance axial supporting force by applying only circular steel pipe-type struts without using H-beams in a strut support structure linearly connecting opposing wales, thus stably supporting the retaining wall and facilitating the application of a connection structure with inclined struts arranged inclinedly.

Hereinafter, the present invention will now be described in detail with reference to embodiments.

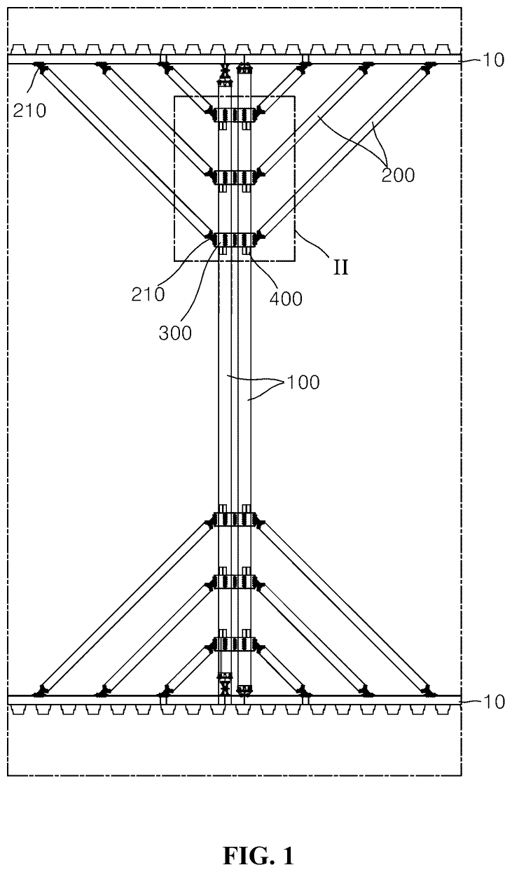

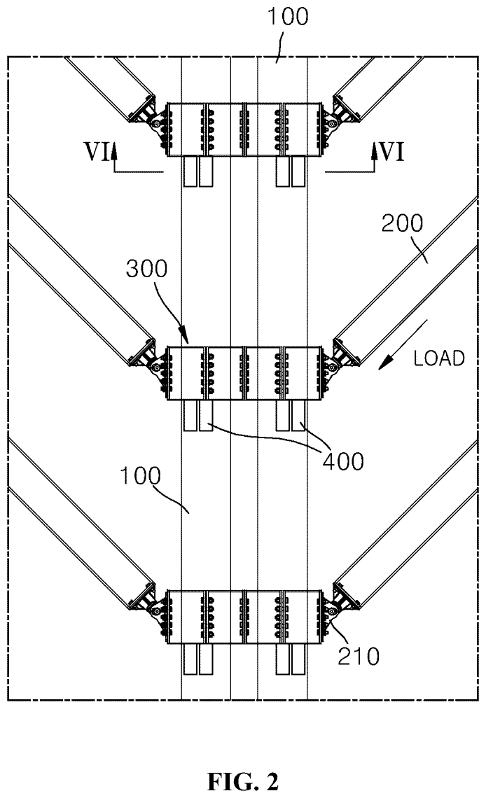

As illustrated in FIGS. 1 and 2, the strut connection device according to an embodiment of the present invention is provided to support wales 10 of a retaining wall installed to support a soil wall or a rock wall, and includes steel pipe struts 100, inclined struts 200, and strut connection brackets 300.

The steel pipe strut 100 supports the wales 10 of the retaining wall, and are linearly arranged orthogonal to the wales between the opposing wales 10. Both ends of the steel pipe strut 100 are respectively connected to the opposing wales 10 through a strut support connection device including connection jacks, thereby providing supporting force to the retaining wall to withstand earth pressure.

Here, the steel pipe strut 100 is formed in a circular pipe shape, as an example.

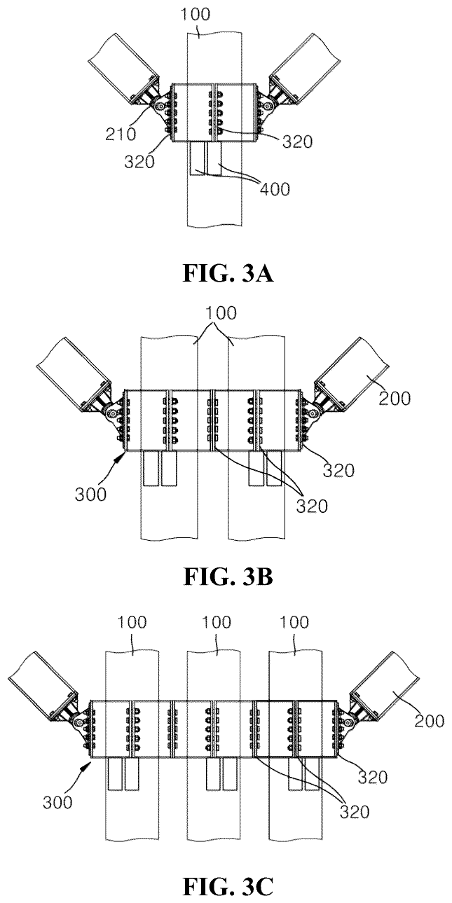

In the embodiment of the present invention, as illustrated in FIGS. 3A to 3C, the steel pipe struts 100 may be installed in one, two, three, or more rows according to the intensity of earth pressure to support the steel pipe struts.

The inclined struts 200 are respectively connected inclinedly to the steel pipe struts 100 and the wales 10 to provide supporting force to the retaining wall, and may be connected inclinedly to the steel pipe strut 100 and the wale 10 at an angle of approximately 45 degrees.

The inclined strut 200 may be, for example, an H-beam, and inclined strut brackets 210 are respectively connected to one end of the inclined strut 200 connected to the wale 10 and the other end of the inclined strut 200 indirectly connected to the steel pipe strut 100. One end of the inclined strut 200 is connected to the wale 10, and the other end is connected to the steel pipe strut 100 to support the steel pipe strut 100.

The inclined struts 200 are symmetrically connected to both sides of the steel pipe strut 100 based on a center axis in the longitudinal direction of the steel pipe strut 100, allowing the steel pipe strut 100 to be more stably and firmly connected to the wale 10. Moreover, the inclined struts 200 disperse the supporting force of the steel pipe strut 100 across a wider area of the wale 10, thereby more firmly supporting the retaining wall.

Next, as illustrated in FIGS. 1 to 5, the strut connection bracket 300 is provided to connect the steel pipe strut 100 and the inclined strut 200.

That is, the strut connection bracket 300 connects the steel pipe strut 100, which supports the wale 10 of the retaining wall, and the inclined strut 200, which is inclinedly connected to the steel pipe strut 100 and the wale 10 to provide supporting force, and includes an arc portion 310 and a connection portion 320.

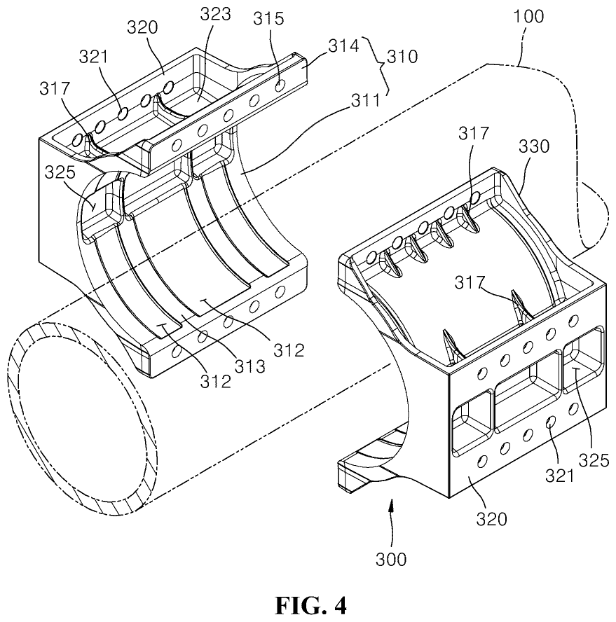

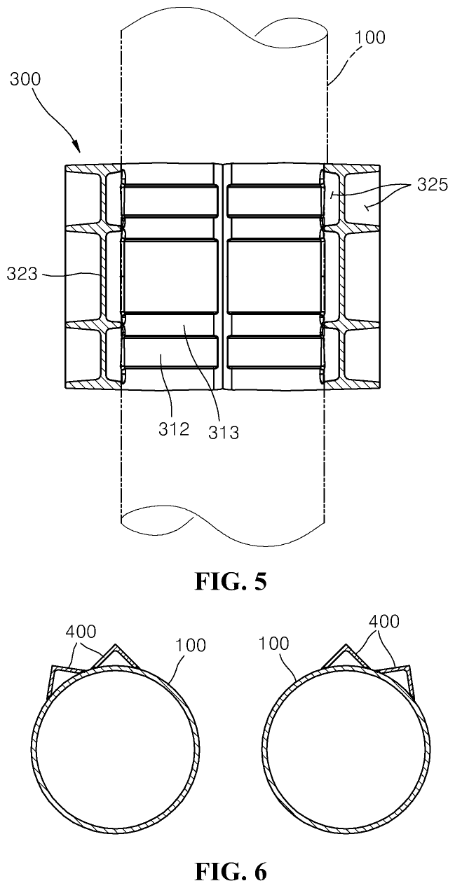

As illustrated in FIGS. 4 and 5, the arc portion 310 includes an arc-shaped body 311 formed in a semicircular shape corresponding to the outer circumferential surface of the steel pipe strut 100, and arc flanges 314 which are bent at the end of the arc-shaped body 311 and have a plurality of first coupling holes 315.

On the inner circumferential surface of the arc-shaped body 311, a plurality of recessed grooves 312 are formed at intervals in the longitudinal direction of the arc-shaped body 311 corresponding to the longitudinal direction of the steel pipe strut 100 to be coupled. That is, relatively protruding protrusions 313 and the recessed grooves 312 are formed alternately in the longitudinal direction of the arc-shaped body 311. When the steel pipe strut 100 is coupled inside the arc-shaped body 311, the outer surface of the steel pipe strut 100 is contact-supported by the surface of the protrusions 313. In this manner, since the protrusions 313 and recessed grooves 312 are alternately formed, even if deformation occurs in the longitudinal direction of the steel pipe strut 100, stable contact and coupling with the outer circumferential surface of the steel pipe strut 100 can be maintained.

The arc flanges 314 are respectively bent at both widthwise ends intersecting the longitudinal direction of the arc-shaped body 311, and have the plurality of first coupling holes 315. Reinforcing ribs 317 may be provided at connection portions between the arc-shaped body 311 and the arc flanges 314 for reinforcement

The connection portion 320 is integrally connected to one side of the arc-shaped body 311 and includes a plurality of second coupling holes 321. The first coupling holes 315 and the second coupling holes 321 are parts where screws are inserted and fastened for coupling with the corresponding components.

In the embodiment of the present invention, as illustrated in FIGS. 4 and 5, the connection portion 320 is formed in a plate shape and is connected to the arc portion 310 through a connection block 323 connected to the center of the outer circumferential surface of the arc portion 310. The connection block 323 is connected at the center of the widthwise cross-section intersecting the longitudinal direction of the arc portion 310.

In the embodiment of the present invention, the strut connection bracket 300 further includes plates 330 which connect both ends of the arc portion 310, both ends of the connection portion 320, and both ends of the connection block 323.

That is, the strut connection bracket 300 may be configured such that multiple components are interconnected through the plates 330, thereby achieving greater rigidity.

For reinforcement, reinforcing ribs 317 may be provided at the connection portion between the arc portion 310 and the connection block 323, and at the connection portion between the connection block 323 and the connection portion 320.

The connection block 323 is provided with at least one weight-reduction groove 325, such that the connection block 323 is formed as a plate structure of a predetermined thickness, thus reducing material costs. Furthermore, even when the connection block 323 has the plate structure, as described above, the connection block 323 can compensate a decrease in rigidity through the plurality of reinforcing ribs 317.

In the embodiment of the present invention, as illustrated in FIGS. 4 and 5, the strut connection brackets 300 may be configured such that the arc portions 310 are arranged symmetrically in a pair to surround the steel pipe strut 100 in the circumferential direction and are joined together via first coupling members inserted into the plurality of first coupling holes 315. Here, the first coupling members and second coupling members, which will be described later, may include screws and nuts.

Additionally, the connection portion 320 may be connected to another adjacent connection portion 320 or to the inclined strut 200.

That is, as illustrated in FIGS. 3B and 3C, the connection portion 320 may be joined to the connection portion 320 of another adjacent strut connection bracket 300 via the second coupling members.

Specifically, when the steel pipe struts 100 are installed in a single row, the connection portion 320 is coupled to the inclined strut bracket 210 connected to the end of the inclined strut 200 via the second coupling member.

In more detail, when the steel pipe struts 100 are installed in a single row, in the state in which the pair of strut connection brackets 300 are joined together via the first coupling members to surround the steel pipe strut 100 in the circumferential direction, the connection portions 320 on both sides are arranged to face outward, and the inclined strut brackets 210 are coupled to the connection portions 320. Furthermore, through the inclined strut brackets 210, the inclined struts 200 can support the retaining wall while maintaining the inclined state.

In addition, as illustrated in FIG. 3A, the connection portion 320 may be coupled to the inclined strut bracket 210 connected to the end of the inclined strut 200 via the second coupling member.

Specifically, when the steel pipe struts 100 are installed in at least two rows, the connection portions 320 of the opposing strut connection brackets 300 respectively arranged between the steel pipe struts 100 of adjacent rows are joined to each other via the second coupling members. The outermost connection portions 320 are coupled to the inclined strut brackets 210 connected to the ends of the inclined struts 200 via the second coupling members.

Meanwhile, in the state in which the steel pipe strut 100 and the inclined strut 200 are coupled via the strut connection bracket 300 and the inclined strut bracket 210, the axial load of the inclined strut 200 acts on the strut connection bracket 300 through the inclined strut brackets 210.

That is, the axial load of the inclined strut 200 is applied to the strut connection bracket 300 in an inclined direction with respect to the steel pipe strut 100. Since the strut connection bracket 300 and the steel pipe strut 100 are not fully integrally fixed to each other to prevent relative movement, there may occur a situation in which the strut connection bracket 300 slides in the longitudinal direction of the steel pipe strut 100.

As described above, if the strut connection bracket 300 fails to maintain the set coupling position and is pushed by the axial load of the inclined strut to move from the initial coupling position, the overall supporting force of the strut connection device may be weakened, resulting in a reduction of the supporting force for supporting the retaining wall.

To prevent the above-mentioned problem, as illustrated in FIGS. 1, 2, and 6, the steel pipe strut 100 is provided with a slip prevention part 400 to prevent the strut connection bracket 300 from sliding in the longitudinal direction of the steel pipe strut 100 due to the load applied by the inclined strut 200.

The slip prevention part 400 may be fixed to the outer surface of the steel pipe strut 100 by welding, screws, or other fastening means, and may be specifically provided to be in contact with one side of the strut connection bracket 300. The slip prevention part 400 comes into contact with the rear end of the strut connection bracket 300 and supports the strut connection bracket 300 so that the strut connection bracket 300 does not slide backward due to the axial load of the inclined strut 200.

The slip prevention part 400 may have a triangular, rectangular, or other cross-sectional shape, and the shape is not particularly limited as long as it can prevent backward slippage of the strut connection bracket 300.

However, since the slip prevention part 400 is separately manufactured and then fixed to the steel pipe strut 100 by welding, screws or other means, it may result in increased workload and reduced work efficiency.

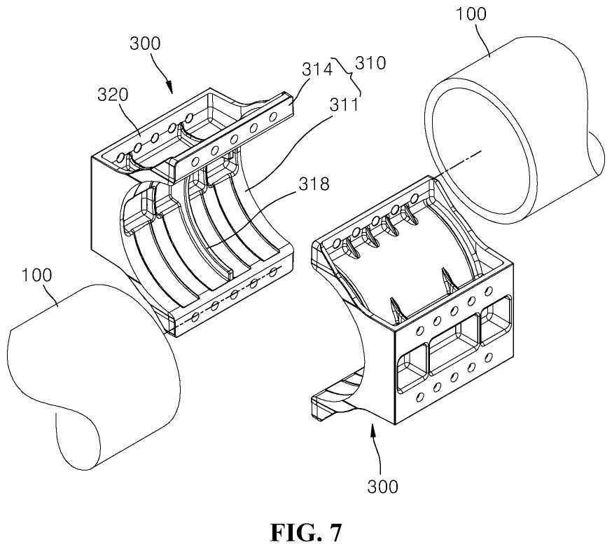

To compensate for the aforementioned disadvantage, in the embodiment of the present invention, as illustrated in FIGS. 7 to 9, an arc-shaped contact support protrusion 318, which has the same center as the inner circumferential surface of the arc-shaped body 311, protrudes from the inner circumferential surface of the arc-shaped body 311.

The contact support protrusion 318 is provided such that one of the first steel pipe struts arranged on one side based on the contact support protrusion 318 inside the arc portion 310 and another second steel pipe strut arranged on the opposite side are connected in a state in which their ends are in contact with and supported by the contact support protrusion 318.

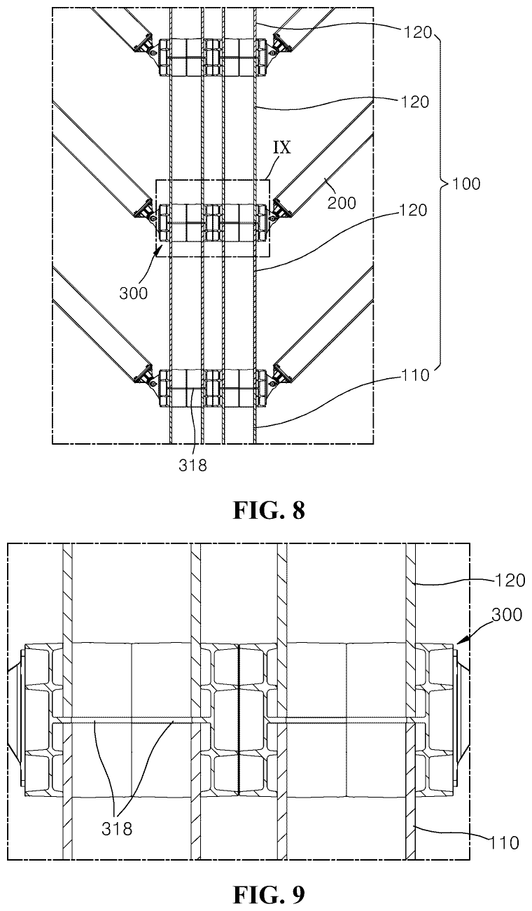

That is, as illustrated in FIG. 8, the steel pipe strut 100 includes a central steel pipe strut 110 positioned at a relatively central portion, and a plurality of auxiliary steel pipe struts 120 of which at least one is arranged on each side of the central steel pipe strut 110 in the longitudinal direction, and which are aligned along the same central axis as the central steel pipe strut 110.

For example, in the relevant drawings, the central steel pipe strut 110 and the first steel pipe strut, the second steel pipe strut, and the third steel pipe strut are arranged in a straight line, and the strut connection brackets 300 are respectively coupled at the connection portions. That is, three auxiliary steel pipe struts 120 are connected to each side of one central steel pipe strut 110, but the number of connections is not limited thereto and may be increased or decreased as needed.

As described above, the strut connection brackets 300 are interposed between the central steel pipe strut 110 and any of the auxiliary steel pipe struts 120, and between the plurality of auxiliary steel pipe struts 120, and each end of the steel pipe strut is in contact with and supported by the contact support protrusion 318. Therefore, even if the axial load of the inclined strut 200 is applied to the strut connection bracket 300, the strut connection bracket 300 is prevented from being pushed and displaced.

As described above, when the strut connection bracket 300 is provided with the contact support protrusion 318, the previously mentioned slip prevention part 400 may be omitted.

Meanwhile, the plurality of auxiliary steel pipe struts 120 are relatively shorter than the central steel pipe strut 110. When the strut connection bracket 300 is provided with the contact support protrusion 318, the auxiliary steel pipe struts 120 can be standardized to be used interchangeably.

In addition, the distance between the opposing wales 10 of the retaining wall may differ depending on construction sites. In such a case, the plurality of auxiliary steel pipe struts 120 with fixed length can be standardized for common use in construction sites, but the length of the central steel pipe strut 110 can be varied according to each site, thereby enabling the auxiliary steel pipe struts to be standardized and commercialized.

While the present invention has been illustrated and described with reference to a preferred embodiment to illustrate the principles of the invention, it should be understood that the present invention is not limited to the specific configurations and operations described. Rather, those skilled in the art will appreciate that various modifications and amendments can be made to the present invention without departing from the spirit and scope of the appended claims.

What is claimed is:

1. A strut connection bracket which connects steel pipe struts supporting wales of a retaining wall and inclined struts inclinedly connected to the steel pipe struts to provide supporting force, the strut connection bracket comprising:
arc portions, each including an arc-shaped body, which is formed in a semicircular shape corresponding to an outer circumferential surface of the steel pipe strut, and arc flanges, which are bent at the end of the arc-shaped body and have a plurality of first coupling holes; and
connection portions, each integrally connected to one side of the arc-shaped body and including a plurality of second coupling holes,
wherein the connection portion is connected to another adjacent connection portion or to the inclined strut.

2. The strut connection bracket according to claim 1, wherein the strut connection brackets are configured such that the arc portions are arranged symmetrically in a pair to surround the steel pipe strut in the circumferential direction and are joined together via first coupling members inserted into the plurality of first coupling holes, and
wherein the connection portion is coupled to a connection portion of another adjacent strut connection bracket via second coupling members, or is coupled to an inclined strut bracket connected to an end of the inclined strut via the second coupling members.

3. The strut connection bracket according to claim 1, wherein the connection portion has a plate shape and is connected to the arc portion via a connection block connected to the center of the outer circumferential surface of the arc portion, and is arranged in parallel with the arc flanges.

4. The strut connection bracket according to claim 3, wherein the connection block includes at least one weight-reduction groove.

5. The strut connection bracket according to claim 1, wherein the inner circumferential surface of the arc-shaped body includes a contact support protrusion configured to be in contact with ends of a first steel pipe strut provided on one side and a second steel pipe strut provided on the other side inside the arc-shaped body to support the steel pipe struts.

6. The strut connection bracket according to claim 1, wherein the inner circumferential surface of the arc-shaped body includes an arc-shaped contact support protrusion formed on the inner circumferential surface of the arc-shaped body to have the same center as the inner circumferential surface of the arc-shaped body.

7. A strut connection device comprising:
steel pipe struts supporting wales of a retaining wall;
inclined struts inclinedly connected to the steel pipe struts and the wales, respectively, and providing supporting force; and
strut connection brackets configured to connect the steel pipe struts and the inclined struts,
wherein the strut connection bracket comprising:
arc portions, each including an arc-shaped body, which is formed in a semicircular shape corresponding to an outer circumferential surface of the steel pipe strut, and arc flanges, which are bent at the end of the arc-shaped body and have a plurality of first coupling holes; and
connection portions, each integrally connected to one side of the arc-shaped body and including a plurality of second coupling holes,
wherein the connection portion is connected to another adjacent connection portion or to the inclined strut.

8. The strut connection device according to claim 7, wherein the steel pipe struts are installed in a single row, and the connection portion is coupled to an inclined strut bracket connected to an end of the inclined strut via second coupling members.

9. The strut connection device according to claim 7, wherein the steel pipe struts are installed in at least two rows, connection portions arranged between adjacent rows of the steel pipe struts are coupled to each other via the second coupling members, and an outermost connection portion is coupled to an inclined strut bracket connected to an end of the inclined strut.

10. The strut connection device according to claim 7, wherein the steel pipe strut includes a slip prevention part configured to prevent the strut connection bracket from sliding in a longitudinal direction of the steel pipe strut due to a load acting on the inclined strut.

11. The strut connection device according to claim 7,
wherein the steel pipe strut includes a central steel pipe strut positioned at a relatively central portion, and a plurality of auxiliary steel pipe struts of which at least one is arranged on each side of the central steel pipe strut in the longitudinal direction, and which are aligned along the same central axis as the central steel pipe strut,
wherein the strut connection brackets are installed between the central steel pipe strut and the auxiliary steel pipe struts, and between adjacent auxiliary steel pipe struts,
wherein the inner circumferential surface of the arc-shaped body includes a contact support protrusion configured to be in contact with the end of the central steel pipe strut and the end of the auxiliary steel pipe strut.

12. The strut connection device according to claim 11,
wherein the contact support protrusion has the shape of an arc with the same center as the inner circumferential surface of the arc-shaped body.
